(19) United States
(12) Patent Application Publication
(10) Pub. No.: US 2015/0019454 A1
(43) Pub. Date: Jan. 15, 2015

(54) METHOD AND SYSTEM FOR CLASSIFYING PARAMETERS OF COMMODITIES REQUIRED FOR GLOBAL SHIPPING AND CUSTOMS CLEARANCE

(71) Applicant: Pitney Bowes Inc., Stamford, CT (US)

(72) Inventors: MARTIN H. HELSETH, Toronto (CA); David W. Coulson, Toronto (CA)

(21) Appl. No.: 13/940,533

(22) Filed: Jul. 12, 2013

(51) Int. Cl. G06Q 10/08

(52) U.S. Cl. CPC G06Q 10/0831
USPC 705/331

(57) ABSTRACT

Consumer goods sold through international ecommerce sites can be classified using pertinent information extracted from data related to previous sales/shipping of commodities. A database stores historical information related to previous sales of commodities, including a description of the commodity, HS code, weight, size, etc. When a consumer makes a purchase of a commodity on-line with a request for an international shipment, the server operating the seller's website provides descriptive information related to the commodity being sold to a classifier server. The classifier server accesses the database and performs a search of the information stored in the database using the information provided by the seller's server to find a best match for the commodity being currently sold. The classifier server will then determine one or more parameters for the commodity based on the historical data stored in the database, that are used to calculate the fully landed cost for the commodity.

### FIELD OF THE INVENTION

The invention disclosed herein relates generally to global shipping and customs clearance services, and more particularly to methods and systems for classifying parameters of commodities required for global shipping and customs clearance services.

### BACKGROUND OF THE INVENTION

The process of shipping commodities across national borders requires classification of the commodities for customs clearance, the calculation and payment of taxes and duties, and to determine if any restrictions apply to such commodities. Global shipping and customs clearance has historically been heavily influenced by manufactures of a limited number of products, shipping thousands of those same products/SKUs to a limited number of retailers around the globe. Customs brokers are typically utilized to facilitate such transactions. These customs brokers have full knowledge of the required information for commercial customs clearance (e.g., known commodity description, Harmonized System (HS) code, country of manufacture/country of origin, shipper, buyer, country of destination, etc.). This allows such commodities to be bulk shipped using freight forwarders and global shippers using a business-to-business (B2B) commercial customs clearance model. All required elements of a shipment are known well in advance of the shipment, and therefore all of the costs associated with such shipment, including required taxes and duties, are known well in advance of the shipment.

With the increase in technology allowing businesses to sell products directly to consumers almost anywhere in the world, the traditional approach to classifying commodities for international shipment is proving to be unworkable. As retailers offer more and more products that can be ordered on-line and shipped anywhere in the world, the ability to provide a purchaser with the complete cost for receiving a single product (or small group of different products), including the actual cost of the product(s), any taxes and duties required, and shipping costs, when a product is ordered is difficult, if not impossible. This is because in most instances the seller is not familiar with the requirements for international shipping and may not be aware of the HS code for a product, which is needed to classify a product and determine such taxes and duties that may be levied upon the product shipped internationally. Consumers, however, desire to know not only how much the product costs, but how much it will cost for them to actually receive the product, referred to as the fully landed cost, before they make an online purchase to enable them to comparison shop and ensure they are getting the best possible deal. The nature of online shopping, however, severely limits that amount of time available for a seller to determine the fully landed cost, in some cases in the order of seconds, as consumers do not want to wait for several minutes for a fully landed cost to be calculated. This time frame does not allow for a product to be classified using the traditional B2B commercial customs clearance model. One way of overcoming this issue is to provide a fully landed cost to the consumer based on the product being classified using an HS code for a general category. However, this is rarely, if ever, accurate, and would often result in the actual fully landed cost being different than the fully landed cost quoted to the customer when the purchase was made. If the actual fully landed cost is more than the quote because the HS code was not accurate, the consumer will be required to pay the additional funds before receiving the product. This often results in a negative shopping experience for the consumer, both with that particular seller, even though the extra cost is not the fault of the seller, and with international ecommerce in general. Such a situation is not desirable for either the consumer or the seller, as the consumer may no longer wish to deal with international vendors, and the seller now loses a customer.

### SUMMARY OF THE INVENTION

The present invention alleviates the shortcomings described above by providing methods and systems for more accurately predicting a parameter for a commodity, e.g., HS Code, weight, and size, in near real time, which allows for more accurate fully landed cost quotes.

According to the present invention, consumer goods sold through international ecommerce sites can be classified in a real time environment (e.g., milliseconds) using pertinent information extracted from data related to previous sales/shipping of commodities. The classification of a commodity can be used to accurately predict the fully landed cost for that commodity. A database is used to store historical information related to previous sales of commodities, including a description of the commodity, HS code, weight, size, etc. When a consumer makes a purchase of a commodity on-line with a request for an international shipment, the server operating the seller's website provides descriptive information related to the commodity being sold to a classifier server. The classifier server accesses the database and performs a search of the information stored in the database using the information provided by the seller's server to find a best match for the commodity being currently sold. The classifier server will then determine one or more parameters for the commodity, e.g., HS code, weight, and/or size, based on the historical data stored in the database. The determined parameters can then be used to calculate the fully landed cost for the commodity. When shipment of the commodity has been completed, the actual information from a customs broker that cleared the shipment of the commodity can be used to update the database for use with future shipments. Such information can also be utilized to evaluate how well the database search is being performed and how accurate the parameters are being determined by the server.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like of corresponding parts.

FIG. 1 illustrates in block diagram form a system for classifying parameters of a commodity according to an embodiment of the present invention; and

FIG. 2 illustrates in flow diagram form the processing performed by the system of FIG. 1 according to an embodiment of the present invention.

### DETAILED DESCRIPTION OF THE PRESENT INVENTION

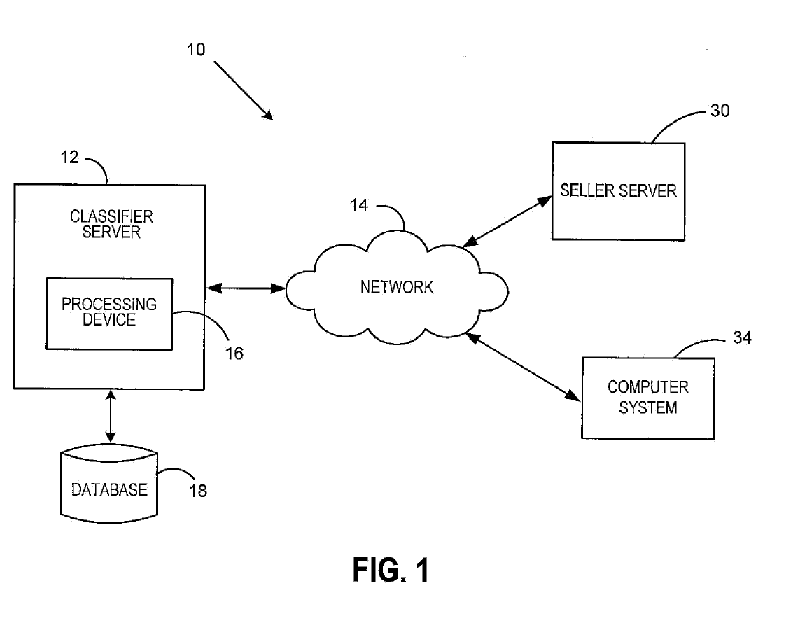

In describing the present invention, reference is made to the drawings, wherein there is seen in FIG. 1 a block diagram of a system 10 for classifying parameters of a commodity required for global shipping and customers clearance. System 10 includes a classifier server 12 that is coupled to a communication network 14, such as, for example, the Internet or any other type of communication network. Server 12 may be a mainframe or the like that is specially constructed for the required purposes, or it may comprise a general purpose computer selectively activated or reconfigured by a computer program (described further below) stored therein. Such a computer program may alternatively be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, which are executable by a processing device 16 within the server 12. One of ordinary skill in the art would be familiar with the general components of a server system upon which the method of the present invention may be performed. Server 12 is in electronic communication with a database 18. Database 18 stores information including, for example and without limitation, data related to previous sale and shipment of commodities internationally. Such data can include, for example, product description, HS code, size, weight, restricted import status for a product to a specific country or countries, export restrictions for a product, etc.

System 10 can also include a server 30 operated by or on behalf of a seller of goods (hereinafter referred to as the seller server). Seller server 30 may be similar to server 12 described above, and is capable of hosting a website for one or more sellers. One of ordinary skill in the art would be familiar with the general components of a server system upon which a website may be hosted. Websites being hosted by the seller server 30 can be accessed via the network 14 by a consumer using a computer system 34. Computer system 34, may be, for example, a personal computer or the like, which can include, for example, smart-phones, tablets, personal data assistants, or any other type of electronic device that has network capability and can allow a user to access the network 14 to send data to and receive data from the seller server 30. It should be understood that the number of seller servers 30 and customer computer systems 34 are not limited in number, and any number can be connected to the network 14.

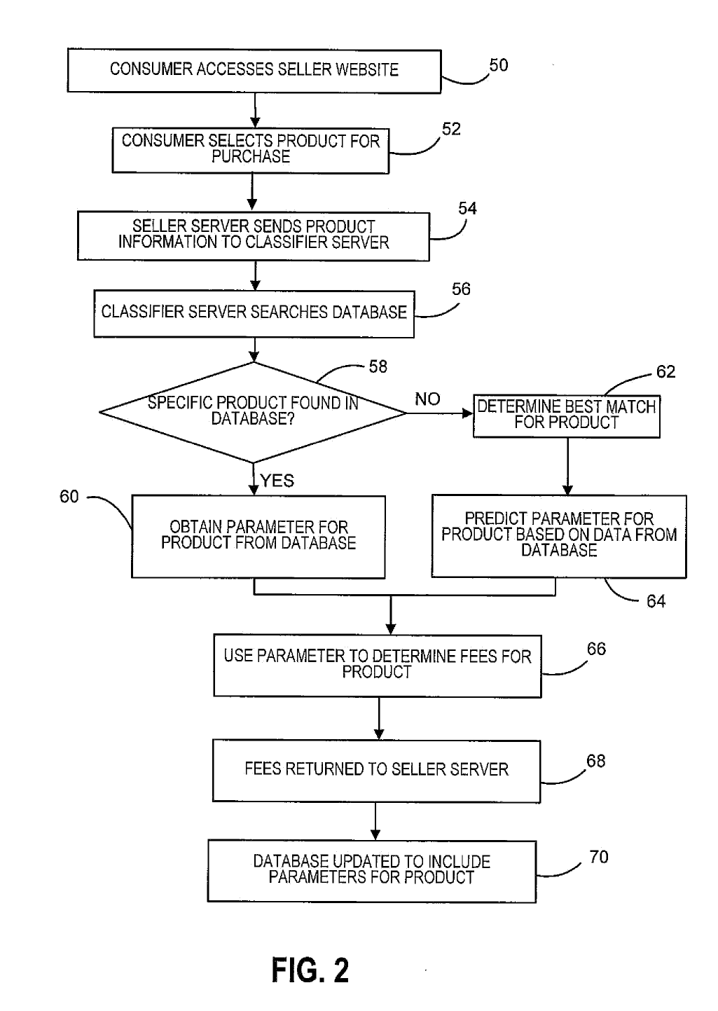

FIG. 2 illustrates in flow diagram form the operation of the system 10 of FIG. 1. In step 50, a consumer utilizing the computer system 34 accesses a seller's website hosted by the seller server 30 to shop for goods. The seller offers products for sale and offers to ship the products internationally. In step 52, the consumer selects a product for purchase, and indicates that it will be shipped to an international destination. In step 54, the seller server 30 sends information related to the product to the classifier server 12. Such information can include any known information about the product selected by the consumer, including, for example, a description of the product, a URL page identifier that describes the product, the type of product, etc. In step 56, the classifier server 12 will search the database 18 to classify one or more specific parameters about the product that are necessary for international shipment and customs clearance for the product. Database 18, as previously described, stores information including, for example and without limitation, data related to previous sale and shipment of commodities (products) internationally, including the HS Code, the size and the weight of products previously shipped. Such data can be obtained from any source, including and without limitation, customs brokers, shipping companies, or any other source. Searching of the database 18 can be performed using any known database search methods, such as, for example and without limitation, key word searches, supervised or unsupervised document classification and/or categorization algorithms, machine learning algorithms, etc.

In step 58, the classifier server 12 will determine if the specific product that is currently being sold is found in the database 18. This will be the case if the product has previously been shipped internationally and the database 18 updated with the information related to the product. If in step 58 it is determined that the specific product is found in the database 18, then in step 60 the desired parameters for the product are pulled from the information in the database 18. Such parameters could include, for example, the HS code for the product, the weight of the product, and the size of the product. Because there are hundreds of millions of different products, and millions more are added by sellers each day, it is likely that the specific product will not already be found in the database 18 in step 58. In this case, then in step 62, the server 12 will use the data stored in database 18 to determine a best match for the product based on the attributes about the product received from the server 30. Using the best match information obtained in step 62, in step 64 the server 12 will predict the required parameters for the product, e.g., HS code, size and weight.

Once the parameters have been obtained or predicted (step 60 or 64, respectively), then in step 66 the parameters are used to determine the fees associated with shipping the product internationally. Such fees could include the shipping costs and the taxes and/or duties imposed by customs for importation of the product. Preferably, the parameters are used to determine the fully landed cost for the product. The parameters can also be used to determine if there are any import/export restrictions applicable to the product. By utilizing the historic data from previous sales of products to classify the parameters, the result is improved classification levels when compared with previous systems that simply utilized group categorization. Improving the commodity level classification results in more accurate HS code classification, which results in more accurate importation cost quoting. It also improves the size and weight accuracy, thereby improving the shipping cost quotes and the ability to screen for oversize goods. It also results in improved restrictions management by improving the ability to identify and apply both import and export restrictions based on an individual commodity instead of a category of commodities.

In step 68, the determined costs for shipping of the product are returned to the seller server 30 for display to the consumer via the computer system 34. The process described above for determining the fully landed cost can be performed very quickly, in the order of milliseconds, therefore making it appear seamless to the consumer and improving the consumer's experience with the seller's website.

In step 70, once the product has been shipped and the parameters have been confirmed during the shipment/customs clearance, the information related to the product can be provided to the classifier server 12 (for example, from the customs broker) and the database 18 updated to include the product for future use if the product is sold again or for use in determining a best match for another related product. In this manner, the database 18 is continuously updated such that future determination of parameters for products will continue to improve resulting in highly accurate cost quoting for e-commerce sales of products.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for determining a fully landed cost for international shipping of a product comprising:
receiving, by a processing device, information related to a product to be shipped internationally;
searching, by the processing device, a database to obtain one or more parameters for the product needed to determine the fully landed cost, the database containing data related to previous sales and shipments of products internationally;
if the product to be shipped is found in the database, obtaining the one or more parameters for the product from the database;
if the product to be shipped is not found in the database, predicting, by the processing device, the one or more parameters for the product based on the data stored in the database for products similar to the product to be shipped;
using, by the processing device, the obtained one or more parameters or the predicted one or more parameters to determine a fully landed cost for international shipping of the product;
receiving, by the processing device, one or more actual parameters for the product after the product has been shipped; and
updating, by the processing device, information stored in the database to include the received actual parameters for the product.

2. The method of claim 1, wherein the one or more parameters includes an HS code for the product, a weight of the product, and a size of the product.

3. The method of claim 1, further comprising:
using, by the processing device, the obtained one or more parameters or the predicted one or more parameters to determine if there are any import or export restrictions for the product to be shipped.

4. A system for determining a fully landed cost for international shipping of a product comprising
a database for storing data related to previous sales and shipments of products internationally; and
a server device coupled to the database and a network, the server device adapted to receive information via the network related to a product to be shipped internationally, the server device being further adapted to search the database to obtain one or more parameters for the product needed to determine the fully landed cost, if the product to be shipped is found in the database, obtain the one or more parameters for the product from the database; if the product to be shipped is not found in the database, predict the one or more parameters for the product based on the data stored in the database for products similar to the product to be shipped; and use the obtained one or more parameters or the predicted one or more parameters to determine a fully landed cost for international shipping of the product; receive one or more actual parameters for the product after the product has been shipped; and update information stored in the database to include the received actual parameters for the product.

5. The system of claim 4, wherein the one or more parameters includes an HS code for the product, a weight of the product, and a size of the product.

6. The system of claim 4, wherein the server device is further adapted to use the obtained one or more parameters or the predicted one or more parameters to determine if there are any import or export restrictions for the product to be shipped.
